(19) United States
(12) Patent Application Publication
(10) Pub. No.: US 2025/0217825 A1
(43) Pub. Date: Jul. 3, 2025

(54) SYSTEMS AND METHODS FOR DATA PROCESSING AND FEATURE RECOGNITION

(71) Applicant: The PNC Financial Services Group, Inc., Pittsburgh, PA (US)

(72) Inventors: Robert JUERGENS, Olmsted Twp, OH (US); David Michael FINK, Wickliffe, OH (US); Stephanie Michelle O'BLOCK, Pittsburgh, PA (US); Mark Anthony RAHIJA, Medina, OH (US); Guy Lee KING, III, Phoenix, AZ (US); Daniel S. WHITE, McCalla, AL (US); Dave E. BLACKETT, Akron, OH (US)

(73) Assignee: The PNC Financial Services Group, Inc., Pittsburgh, PA (US)

(21) Appl. No.: 19/004,182

(22) Filed: Dec. 27, 2024

Related U.S. Application Data
(60) Provisional application No. 63/616,067, filed on Dec. 29, 2023.

(51) Int. Cl. G06Q 30/0201

(52) U.S. Cl. CPC G06Q 30/0201

(57) ABSTRACT

A computer-implemented method for performing a data processing and feature recognition processes. The method includes processing user transaction data associated with user transactional behaviors in a multi-layered data storage system, providing a user transactional behavior dataset at a processor, and collecting a plurality of user transactional behavior data associated with the user transactional behavior dataset.

### CROSS REFERENCE TO RELATED APPLICATIONS

This application claims the benefit of priority of U.S. Provisional Patent Application No. 63/616,067 filed on Dec. 29, 2023, the contents of which are incorporated herein by reference in their entirety.

### TECHNICAL FIELD

The present disclosure relates generally to systems and methods for data processing feature recognition. More specifically, and without limitation, this disclosure relates to automatically processing and storing a consolidated, secured, standardized representation of transactional data that enables life-of-a-transaction analysis and the identification and delivery of actionable insights at the right-time, to the right stakeholder, and in the right channel.

### BACKGROUND

In a digital age, data scientists, data modelers, financial analysts, marketing advisors, and other lines of business analysts (collectively, “data users”) in a financial institution routinely analyze massive amounts of data that the financial institution collects from daily transactions (collectively, “big data”). The large and complex big data are collected and stored in digital storage for later processing by traditional data-processing systems and methods. Data users may face issues with extracting value from big data using these traditional data-processing systems and methods, such as predictive analytics, user behavior analytics, or certain other advanced data analytics methods. Data users require access to current and historical transaction data in a standard, easy to use format.

While using transactional data by a source system is most comprehensive in analyzing user behavior, using integrated and standardized data would greatly improve efficiency and inter-departmental cooperation for financial institutions when analyzing big data. Many financial institutions' enterprise data users spend a significant amount of time researching, sourcing, and integrating data for a specific business need. Multiplying the time spent across many groups trying to accomplish the same goal, using the same data, leads to high business costs.

There is a need to overcome these and other drawbacks of existing systems and for improved systems and methods for processing information.

### SUMMARY

In view of the foregoing, embodiments of the present disclosure provide computer-implemented systems and methods for performing a data processing and feature recognition. For example, in various exemplary embodiments, systems and methods for processing user transactional data associated with user transactional behaviors in a multi-layered data storage system are disclosed. The method may include providing a user transactional behavior dataset at a processor, the user transactional behavior dataset may include a plurality of user transactional behavior data collected by the system, wherein each data point may further include one or more approximate feature attributes. The method may further include generating, with the processor, a first sub-dataset in a first data storage layer of the multi-layered data storage system, wherein the first sub-dataset may include approximate feature attributes requested by a first user. The method may further include calculating, with the processor, the approximate feature attributes of the first sub-dataset, based on one or more adjusted feature attributes. The method may further include generating, with the processor, a second sub-dataset, wherein a data identifier feature value may be attached to each data element of the second sub-dataset, so that a data element of the second sub-dataset can be traced back to a corresponding data element in the first sub-dataset. The method may further include outputting the second sub-dataset. The method may further include storing the second sub-dataset in a second data storage layer, wherein the adjusted feature attributes may be provided by the first user or are generated based on the value of one or more data-points within the first sub-dataset. In some embodiments, the second sub-dataset may be provided to a second user when the second user requests a dataset including one or more approximate feature attributes.

Embodiments in accordance with this disclosure include systems and methods for processing user transaction data associated with user transactional behaviors in a multi-layered data storage system. The system may include a processor, collecting at least one user transactional behavior dataset of the user transactional behavior data. In some embodiments, the user transactional behavior data may include a plurality of user transactional behavior data. In some embodiments, each data point may further include one or more approximate feature attributes. In some embodiments, the processor may generate a first sub-dataset in a first data storage layer of the multi-layered data storage system. In some embodiments, the first sub-dataset may include approximate feature attributes requested by a first user. In some embodiments, the processor may calculate the approximate feature attributes of the first sub-dataset, based on one or more adjusted feature attributes. In some embodiments, the processor may generate a second sub-dataset. In some embodiments, a data identifier feature value may be attached to each data element of the second sub-dataset, so that a data element of the second sub-dataset can be traced back to a corresponding data element in the first sub-dataset. In some embodiments, the adjusted feature attributes may be provided by the first user or may be generated based on the value of one or more data elements within the first sub-dataset. In some embodiments, the second sub-dataset may be provided to a second user when the second user requests a dataset including one or more approximate feature attributes. In some embodiments, the system further includes a first memory, configured to host a first data storage layer, storing the first sub-dataset. In some embodiments, the system further includes a second memory, configured to host a second data storage layer, storing the second sub-dataset.

It is to be understood that the foregoing general description and the following detailed description are exemplary and explanatory only and are not restrictive of the disclosed embodiments.

### BRIEF DESCRIPTION OF DRAWINGS

The accompanying drawings, which comprise a part of this specification, illustrate several embodiments and, together with the description, serve to explain the principles and features of the disclosed embodiments. In the drawings:

FIG. 1 is a diagram of an exemplary system for performing data processing and feature recognition, consistent with disclosed embodiments.

FIG. 2 is an exemplary flow diagram for performing data processing and feature recognition, consistent with disclosed embodiments.

FIG. 3 is a block diagram of an exemplary system for performing data processing and feature recognition, consistent with disclosed embodiments.

FIG. 4 is a block diagram of an exemplary system for performing data processing and feature recognition, consistent with disclosed embodiments.

FIG. 5 is an exemplary dataset of an exemplary system for performing data processing and feature recognition, consistent with disclosed embodiments.

FIG. 6 is a flowchart of an exemplary system for performing data processing and feature recognition, consistent with disclosed embodiments.

FIG. 7 is an exemplary dataset of an exemplary system for performing data processing and feature recognition, consistent with disclosed embodiments.

FIG. 8 is a flowchart of an exemplary system for performing data processing and feature recognition, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added or steps may be removed without departing from the envisioned embodiments. Thus, the materials, methods, and examples are illustrative only and are not intended to be limiting.

Disclosed embodiments provide systems and methods for data processing and feature recognition. Data users may submit their requests to a data query system, in which the data query system can load raw data from a database, process raw data, and represent data in a standard format and in a standard data layer. The requested datasets are to be produced with a streamlined set of attributes, while recognizing that there are many different business needs, other attributes are not wiped-out from the raw data and are optional to be provided with the integrated data at the same time. The system allows internal users to layer in additional attributes related to the transaction, customer, product, and/or account information to customize the dataset to their business needs. The internal user may use artificial intelligence (“AI”) and machine learning to analyze the data.

The integrated dataset may be extended to other platforms or third-party programs for further analysis, for example, cooperating with government investigations, such as anti-money laundering investigations.

Once the integrated dataset is created, the requester and other internal consumers may use that dataset without the need to re-run analysis. In some embodiments, the system stores the integrated dataset, leading to increased efficiency as more integrated data is stored over time.

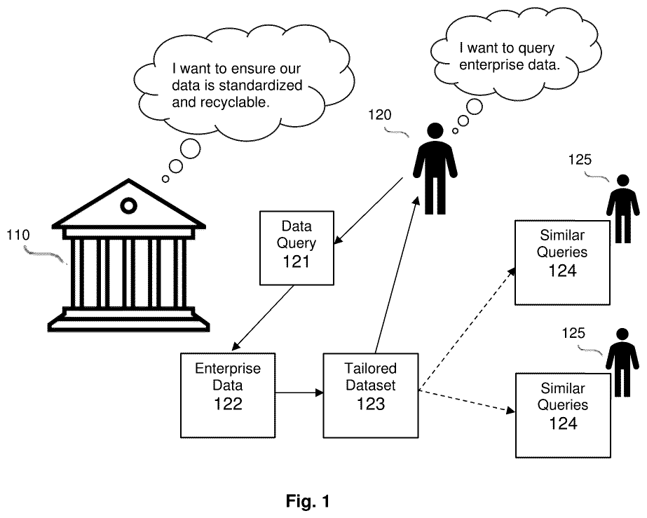

FIG. 1 illustrates an exemplary application of a data processing and feature recognition process, consistent with disclosed embodiments. The systems and methods disclosed herein improve security of data processing and feature recognition, while also allowing entity 110 and user 120 to ensure that the process is compliant with their specific needs. The disclosed systems and methods may be applicable to any number of users 120, entities 110, or any other individuals or entities consistent with the present disclosure.

As illustrated in FIG. 1, entity 110, which may be an individual, a financial institution, or an organization may need to ensure its data is standardized and recyclable. User 120 may work for entity 110 and may wish to query the entity's 110 enterprise data 122. For example, enterprise data 122 may include, but is not limited to, transactional information such as user name, age, address, wire transfer, account withdraw, credit card, mortgage, and salary income information. User 120 may send a data query 121 to the system, and according to disclosed embodiments, the system may query the enterprise data 122 and provide query results in the form of a tailored dataset 123, which may be provided to user 120 in response to the data query 121.

In some embodiments, other users 125 may send similar data queries 124 to the system, which may verify that an existing tailored dataset 123 is responsive to the similar data query 124. In some embodiments, the system outputs the existing tailored dataset 123 to the other users in response to their similar queries.

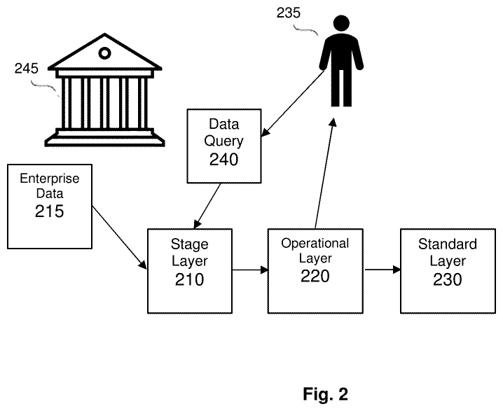

FIG. 2 illustrates an example flow environment for performing data processing and feature recognition, consistent with the disclosed embodiments. As shown in FIG. 2, there may be a data processing and feature recognition system to implement the standardization and recycling needs illustrated in FIG. 1.

As illustrated in FIG. 2, the data processing and feature recognition process may include a variety of steps. These steps may be performed in the order illustrated in FIG. 2 or may be performed in a different order. After a data user 235 submits a data query 240 to the system, the system queries the data in a stage layer 210. The stage layer 210 is a data layer that may store all enterprise data 215, e.g., transactional data from an entity 245. In some embodiments, the stage layer 210 may be an existing data warehouse application. In some embodiments, the stage layer 210 may be an existing data warehouse application that is capable of processing data and transmitting the data to an operational layer 220. In some embodiments, data users do not have access to the stage layer 210. In some embodiments, data administrators have access to the stage layer 210.

After data is processed in stage layer 210, the data may be transmitted to operational layer 220. In some embodiments, at operational layer 220, data may be available to all approved data users 235. In some embodiments, the operational layer 220 provides approved data user access to source system transaction data in the native format within a single dataset allowing users to conduct analytics on a particular source system or subject matter area. In some embodiments, the operational layer 220 is a database management system including a graphical user interface (“GUI”).

After data is transmitted to the operational layer 220 and accessed by at least one data user, the data may be further processed and stored in a standard layer 230. In some embodiments, data in the standard layer 230 is further processed based on common transactional data attributes across multiple operational datasets into a standardized structure. In some embodiments, each data in standard layer 230 provides users with detailed information of a financial transaction. In some embodiments, the detailed information includes the data's point of origin, a source system the data first post to, and a general ledger the data first post to. In some embodiments, the granular level of details is also tagged with an ISO20022 transaction code to allow for standardization of transactions across source systems within or outside of the financial institution, allowing the financial institution to cooperate with outside agencies, for example, with anti-money laundering authorities. In some embodiments, each dataset also contains a summary of the customer, financial product, and account information at the point of the transaction, allowing data users to further trace the data from the standard layer 230 to the operational layer 220 for additional source system detail not standardized across systems.

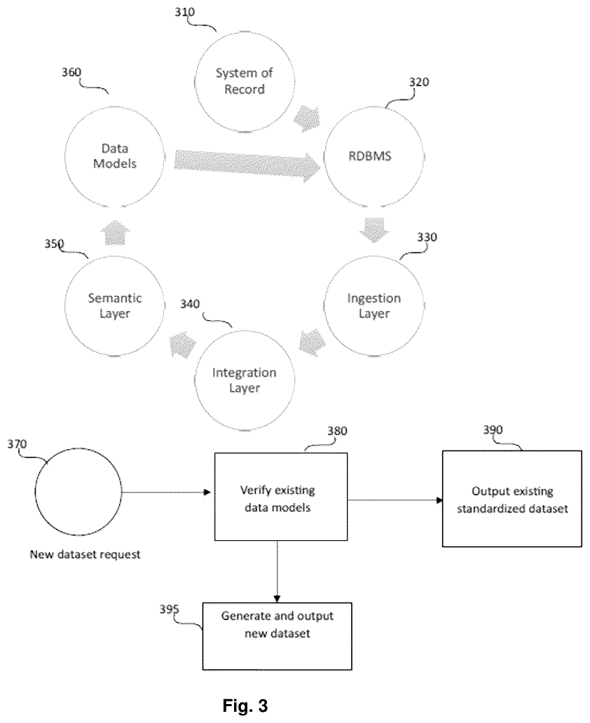

FIG. 3 illustrates an example flow environment for performing data processing and feature recognition, consistent with the disclosed embodiments. As shown in FIG. 3, there may be a data processing and feature recognition system to implement the standardization and recycling needs described above with respect to FIG. 2.

As illustrated in FIG. 3, the data processing and feature recognition process may include a variety of steps. These steps may be performed in the order illustrated in FIG. 3 or may be performed in a different order. The embodiment shown in FIG. 3 is merely illustrative.

After a data user submits a data query to the system, the system may query the data in a system of record 310. In some embodiments, the system of record 310 is an information storage system of a financial institution commonly implemented on a computer system running a database management system. In some embodiments, the system of record 310 is an authoritative data source in the financial institution for transactional data. In some embodiments, system of record 310 includes, but is not limited to, transactional information such as user name, age, address, wire transfer, account withdraw, credit card, mortgage, and salary income information.

After the system queries the data in a system of record 310, relevant data may be transmitted to an open relational database management system (“RDBMS”), such as RDBMS 320 that runs on operating systems such as Windows®, Unix®, and Linux®. RDBMS 320 may include software allowing database managers to create, manage, and/or access relational databases. RDBMS 320 may be configured to structure and/or organize data to improve the database manager's ability to identify and manage relationships between data stored in RDBMS 320. In some embodiments, RDBMS 320 may include data unification features, data analytics features, and cloud analytics features, which may use artificial intelligence solutions to improve data management and analysis for relational databases. In some embodiments, RDBMS 320 may include or be configured to operate in conjunction with cloud analytics software.

After the RDBMS 320 receives data from the system of record 310, the RDBMS 320 may transmit data to an ingestion layer 330. In some embodiments, the ingestion layer 330 is a data layer that stores all transactional data. In some embodiments, the ingestion layer 330 is a landing zone for all transactional data. For example, the ingestion layer 330 as a landing zone serves as an intermediate storage used for data processing during the processing and feature recognition processes that extract, transform, and load datasets from the raw database. In some embodiments, the ingestion layer 330 as the landing zone of data enables the system to be a cloud-based system. For example, in some embodiments, storing data on a server, such as ingestion layer 330, may allow users cloud access to the data without moving the data from the server. In some embodiments, the server may be directly accessed through the cloud, or may host data through the cloud. In some embodiments, the ingestion layer 330 as the landing zone creates a security baseline for all data processing and feature recognition implementations. In some embodiments, the security baseline involves confirming compliance with one or more security requirements. In some embodiments, the security baseline involves the creation of one or more security requirements associated with the data stored in the ingestion layer 330. The security requirements may include storage requirements, such as encryption, and/or access requirements, such as login, two-factor authentication, public/private keys, and the like. In some embodiments, ingestion layer 330 may be programmed with one or more data security compliance checks, which may involve screening incoming data for malware or other malicious software, and/or may involve reviewing the incoming data for data security compliance or breaches. In some embodiments, the ingestion layer 330 may be an existing data warehouse application. In some embodiments, the ingestion layer 330 may be an existing data warehouse application that is capable of processing data and transmitting the data to an integration layer 340. Processing the data may involve one or more security checks described above and/or may involve transforming the data into a standard data format for storage in the ingestion layer 330 or the integration layer 340. In some embodiments, data users do not have access to the ingestion layer 330. In some embodiments, data administrators have access to the ingestion layer 330. In some embodiments, the ingestion layer 330 may correspond to a stage layer 210, as described in prior paragraphs.

After data is processed in the ingestion layer 330, the data may be transmitted to the integration layer 340. In some embodiments, at integration layer 340, data is available to all approved data users. In some embodiments, the integration layer 340 provides approved data users access to source system transaction data in the native format within a single dataset allowing users to conduct analytics on a particular source system or subject matter area. In some embodiments, the integration layer 340 is a database management system including a graphical user interface (“GUI”). In some embodiments, the integration layer 340 is also called an operational layer. The integration layer 340 may be structured as an abstraction layer configured to permit access by users to data that, in some embodiments, may be otherwise inaccessible, or that may be protected by permissions. In some embodiments, data stored in other layers may be accessible only by administrative users, while data stored in the integration layer 340 may be accessible by non-administrative users. In some embodiments, login credentials and/or other security compliance procedures are needed to access data stored in the integration layer 340. In some embodiments, the data stored in the integration layer 340 may be encrypted or may otherwise be protected from general access. In some embodiments, the data stored in the integration layer 340 may be arranged to facilitate access to the data by general users, and/or may be arranged for purpose-based access to data, such as common data queries or commonly requested query results.

After data is transmitted to the integration layer 340 and accessed by at least one data user, the data may be further processed and stored in a semantic layer 350. In some embodiments, data in the semantic layer 350 is further processed based on common transactional data attributes across multiple operational datasets into a standardized structure. In some embodiments, each data element in semantic layer 350 provides users with detailed information of a financial transaction. In some embodiments, the detailed information includes the data's point of origin, a source system the data first posted to, and a general ledger the data first posted to. Once the user has the detailed information of the data element, the user may easily trace the processed data element to its original data source and conduct investigations with the raw data. In some embodiments, the granular level of details is also tagged with an ISO20022 transaction code to allow for standardization of transactions across source systems within or outside of the financial institution, allowing the financial institution to cooperate with outside agencies, for example, with anti-money laundering authorities. In some embodiments, each data element or dataset also contains a summary of the customer, financial product, and account information at the point of the transaction, allowing data users to further trace the data from the semantic layer 350 to the integration layer 340 for additional source system details not standardized across systems. In some embodiments, the semantic layer 350 transmits the dataset to RDBMS 320 for archive and storage.

After the data is further processed by the semantic layer 350 into respective datasets, the datasets may be further stored as specified data models 360. In some embodiments, the data models 360 include, but are not limited to, model development for fraud analytics, model development for deposit analytics, model development for corporate and institutional banking clients, model development for retail, and model development for finance.

The data models 360 may include software directed to specific data query use-cases or data use use-cases. In some embodiments, the data models 360 may include common software, that may be abstracted into a software library or may be stored in each individual data model 360. In some embodiments, the data models 360 may include artificial intelligence software configured to enhance data manipulation and access based on subject matter associated with the data models 360. The artificial intelligence software may include receiving subject-matter-based data and sample query requests and results as training data. In some embodiments, the training data may be used to train the artificial intelligence software, such that the artificial intelligence software receives the subject-matter-based data and sample query requests and is configured to output the sample query results. The training may further include revising the artificial intelligence software to output different sample query results if a result output by the software does not match an expected or intended result. Each of fraud analytics, deposit analytics, corporate and institutional banking clients, retail, and finance may include subject-matter-specific data or query requests.

For example, data for fraud analytics may include one or more indicators of fraud, such as the presence of multiple, erratic payments, payments in a location not associated with a card user, large payments, etc. This data may be used to calculate a risk of fraud score based on fraud risk analytics in association with the model for fraud analytics. In some embodiments, query of the data associated with the model for fraud analytics may include requests for data associated with calculation of the fraud risk score. As can be seen, queries associated with other models, such as the model for finance, may not involve requests for such data. Thus, separate models may be developed to manage separate data and different types of expected queries based on the subject matter of data models 360. In some embodiments, the data models 360 are standardized data models. In some embodiments, the data models are further transmitted to a sand box layer that is not shown in FIG. 3. The sand box layer may further archive and distribute the models to data users.

In some embodiments, as illustrated in the process block diagram starting with the new dataset request step 370, a data user may submit a new dataset request to the system. The system may query the existing data models and verify if there are existing data models that may satisfy the data user's request, as illustrated in step 380. As described above, data models 360 may involve subject-matter-specific data and/or expected queries. As such, verifying whether there are existing data models may involve comparing data associated with the new dataset request with subject matter data of each data model 360 to determine whether the data of the new dataset matches the data of any data model 360. Additionally and/or alternatively, verifying whether there are existing data models may involve comparing a user's query to the expected queries associated with data models 360. If the system recognizes that there are existing datasets containing features requested by the data user, the system delivers and outputs the existing standardized datasets to the data user, as shown in step 390. If the system cannot recognize among existing standardized datasets that any dataset may satisfy a data user's request, the system generates and outputs a new dataset to the data user as illustrated in step 395. As described above, the data query system may load raw data from a database, process raw data, and represent data in a standard format and in a standard layer. The requested datasets may be produced with a streamlined set of attributes according to business needs, while other attributes are optional to be provided with the integrated data at the same time. The system allows users to layer in additional attributes related to the transaction, customer, product, and/or account information to customize the dataset to their business needs.

As described above, the disclosed system and method in FIG. 3 enables a data processing and feature recognition process in a multilayered database that may generate standardized and recyclable financial institution datasets and data models, reducing redundant research requests.

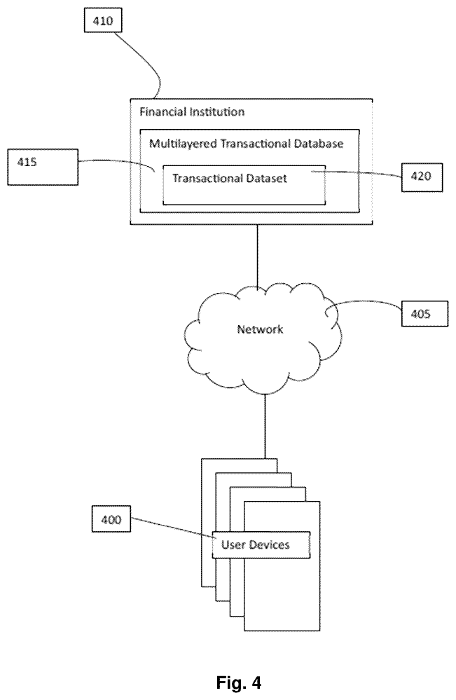

FIG. 4 is a diagram of an exemplary system environment for performing a data processing and feature recognition process, consistent with disclosed embodiments. System environment may include one or more user devices 400, one or more networks 405, at least one financial institution 410, one or more multilayered transactional databases 415, and one or more transactional datasets 420, as shown in FIG. 4.

The various components of user devices 400 may communicate over a network 405. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment is shown as a network-based environment, it is understood that in some embodiments, one or more aspects of the disclosed systems and methods may also be used in a localized system, with one or more of the components communicating directly with each other.

User devices 400 may be configured such that data user may access a protected navigation location through a browser or other software executing on user device 400. As used herein, a protected navigation location may be any network location deemed sensitive, e.g., a network location containing customer identification information. Activity of a user at the network location may be audited to provide increased accountability for the user. For example, a protected navigation location may include a particular URL (or URL domain, etc.), a network location internal to an organization, or any other sensitive network location. User device 400 may include any form of computer-based device or entity through which data user may access a protected navigation location. For example, user device 400 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an loT device (e.g., smart home devices, industrial devices, etc.), or any other device that may be capable of accessing web pages or other network locations. In some embodiments, user device 400 may be a virtual machine (e.g., based on AWS™, Azure™, IBM Cloud™, etc.), container instance (e.g., Docker™ container, Java™ container, Windows Server™ container, etc.), or other virtualized instance. Using the disclosed methods, activity of data user through user device 400 may be monitored and recorded by a browser extension executing on user device 400. User device 400 may communicate with financial institution 410 through network 405. For example, user device 400 may receive a web link to submit requests.

Financial institution 410 may include any form of remote computing device configured to receive, store, and transmit data. For example, financial institution may own a server configured to store the multilayered transactional database 415 and transactional dataset 420, accessible through a network (e.g., a web server, application server, virtualized server, etc.). User device 400 may interact with the multilayered transactional database 415, for example, to receive and/or store information. Multilayered transactional database 415 may be included on a volatile or non-volatile, magnetic, semiconductor, tape, optical, removable, non-removable, or other type of storage device or tangible or non-transitory computer-readable medium. Multilayered transactional database 415 may also be part of user device 400 or separate from user device 400. When multilayered transactional database 415 is not part of user device 400, user device 400 may exchange data with multilayered transactional database 415 via a communication link. Multilayered transactional database 415 may include one or more memory devices that store data and instructions used to perform one or more features of the disclosed embodiments. Multilayered transactional database 415 may include any suitable databases, ranging from small databases hosted on a workstation to large databases distributed among data centers. Multilayered transactional database 415 may also include any combination of one or more databases controlled by memory controller devices (e.g., server(s), etc.) or software. For example, multilayered transactional database 415 may include document management systems, Microsoft SQL™ databases, SharePoint™ databases, Oracle™ databases, Sybase™ databases, other relational databases, or non-relational databases, such as mongo and others. Although one multilayered transactional database 415 is shown in FIG. 4, the system environment may include one or more multilayered transactional database 415, which may be used to store various types of information associated with customers of the financial institution 410.

As described above, user device 400 may be one or more devices configured to allow data to be received and/or transmitted by the system (e.g., a server, etc.) and may include one or more dedicated processors and/or memories. For example, user device 400 may include a processor (or multiple processors) and a memory (or multiple memories), not shown in the figures. User device 400 may include one or more digital and/or analog devices that allow user device 400 to communicate with other machines and devices, such as other components of the system. User devices 400 may include one or more input/output devices. User device 400 may include a screen for displaying communications to a user. User device 400 may include other components known in the art for interacting with a user. User device 400 may also include one or more digital and/or analog devices that allow a user to interact with the system, such as touch-sensitive area, keyboard, buttons, or microphones.

Processor, not shown in the figures, may take the form of, but is not limited to, one or more integrated circuits (IC), including application-specific integrated circuit (ASIC), microchips, microcontrollers, microprocessors, embedded processor, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations. Furthermore, according to some embodiments, the processor may be from the family of processors manufactured by Intel®, AMD®, Qualcomm®, Apple®, NVIDIA®, or the like. The processor may also be based on the ARM architecture, a mobile processor, or a graphics processing unit, etc. The disclosed embodiments are not limited to any type of processor configured in user device 400.

Memory may include one or more storage devices configured to store instructions used by the processor to perform functions related to user device 400. The disclosed embodiments are not limited to particular software programs or devices configured to perform dedicated tasks. For example, the memory may store a single program, such as a user-level application, that performs the functions associated with the disclosed embodiments, or may comprise multiple software programs. Additionally, the processor may, in some embodiments, execute one or more programs (or portions thereof) remotely located from user device 400. Furthermore, memory may include one or more storage devices configured to store data for use by the programs. Memory may include, but is not limited to a hard drive, a solid state drive, a CD-ROM drive, a peripheral storage device (e.g., an external hard drive, a USB drive, etc.), a network drive, a cloud storage device, or any other storage device.

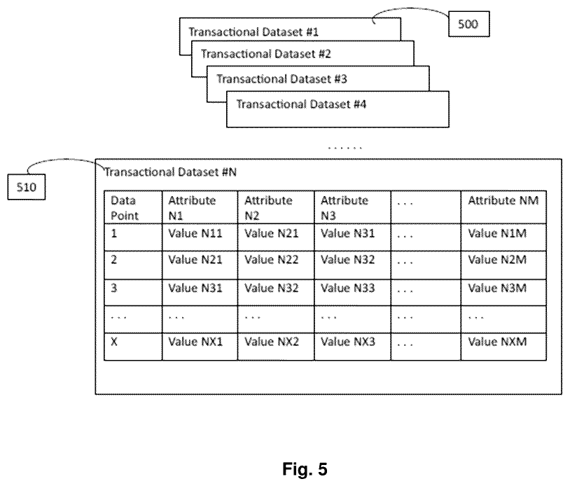

FIG. 5 is an exemplary diagram of transactional datasets 500. The dataset 500 is an example of raw data in the stage layer 210 or ingestion layer 330. In some embodiments, a transactional dataset 510 is presented to a data user. The transactional dataset 510 is the number N among all the existing datasets stored in a transactional database. Exemplary transactional dataset 510 has X rows and M columns. Each data cell of the transactional dataset 510 may be granted a value NXM, in which N is the identifier of the dataset, X is the identifier of the row, and M is the identifier of the column. In some embodiments, the transactional dataset 510 includes more than three identifiers for locating each data cell. In some embodiments, the dataset includes user names, account numbers, address, salary, credit card transactions, wire transfer transactions, social security numbers, and other relevant demographic and financial transaction information.

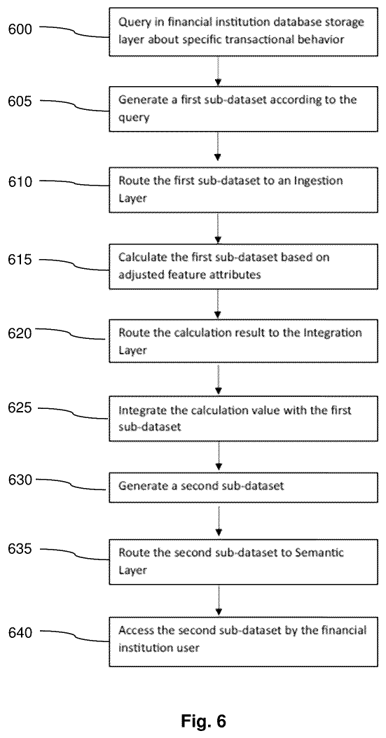

FIG. 6 is a flowchart of an exemplary method for data processing and feature recognition, according to some embodiments. The method may be performed by at least one processing device of a computing device, such as a processor in user devices 400, as described above. The method may be used to implement steps 330, 340, and 350 in a method as discussed in FIG. 3 above.

In step 600, the method may include querying financial institution database storage layers including stage layer 210 or ingestion layer 330 about specific transactional behavior. The computing device may generate the query based on the type of data feature requested. For example, if the data user is querying about an individual customer, the system may respond by providing a dataset that may include data fields of customer name, address, phone number, date of birth, etc. If the data user is researching business customers, the system may include data fields of business name of the customer, address, identity information of a beneficial owner who owns an interest in the customer, along with identity information of the individual managing the business customer, etc.

In step 605, the method may include generating a transactional sub-dataset from a multilayered database. For example, the data user may request information associated with a particular customer from a certain geographical area, for example, the state of Pennsylvania. If no such information is available, then the computing device may respond to the data user that no data is available. For example, if no corresponding customer lives in the state of Pennsylvania, then the system may respond to the user that no customer living in the state of Pennsylvania is available. If relevant data is available, the system may generate a first sub-dataset, for example, a sub-dataset that includes customers living in the state of Pennsylvania, from a raw dataset including customers living in the United States of America, their phone numbers, their account numbers, and other relevant information.

In step 610, the method may include routing the first sub-dataset to an ingestion layer, such as ingestion layer 330 to further process the first sub-dataset for feature recognition. The ingestion layer 330 may provide a landing zone for the first sub-dataset, which may serve as an intermediate storage used for data processing during the processing and feature recognition process that extracts, transforms, and loads datasets from the raw database, as discussed in the prior paragraphs. For example, the computing device may output the customer information dataset generated from a query for customers from a specific geographic region from a data warehouse storage location to a data processing location.

In step 615, the method may include calculating the first sub-dataset based on adjusted feature attributes from the completed data fields. In some embodiments, there are multiple data users querying similar data features at the almost the same time. Each data user may not know other's tasks or goals. The system may calculate adjusted features based on different standards. In some embodiments, the system recognizes that multiple data users are querying similar features in real-time and collects all the combined relevant data features, to be presented to each data user requesting data at the same time. For example, one data user may request credit card payment default information and another user may request salary decrease information. In some embodiments, the system may then recommend both features to both users. In some embodiments, the system may also recommend data users submit data requests within a certain period of time. For example, the system may recommend similar featured data requests to data users in a financial institution's taxation department during tax seasons each year, i.e., January 1 to April 15.

In step 620, the method may include routing the result of the calculation to the integration layer. In some embodiments, the system calculates the requested feature according to the standard discussed in the above paragraph and outputs the result in the form of a sub-dataset to an integration layer. For example, the data user may request data for financial institution customer credit line increase, in which case the system may calculate the need based on prior and ongoing data requests it has taken and may provide, in a calculated sub-dataset, a set of features including customer name, credit line increase, date of birth, salary in recent years, and mortgage information, etc.

In step 625, the method may include integrating the calculation value with the first sub-dataset. In some embodiments, the system may calculate the request feature and output the result in the form of a sub-dataset to an integration layer, dismissing certain features. For example, the data user may request data for financial institution customer credit line increases in a certain zip code area, in which case the system may calculate the need based on prior and ongoing data requests and provide, in a calculated sub-dataset, a set of features including customer name, credit line increase, date of birth, salary in recent years, and mortgage information, etc. As such, to form a sub-dataset, one or more data elements may be omitted relative to the dataset. In some embodiments, omitting or ignoring one or more data elements may allow the system to analyze remaining data based on one or more different criteria unavailable for analysis of the full dataset.

In step 630, the method may include generating a second sub-dataset. In some embodiments, the second sub-dataset removes certain features in the first sub-dataset that are not related to the data user's request. In some embodiments, the second sub-dataset includes the features requested by the data user and recommended by the system.

In step 635, the method may include routing the second sub-dataset to a semantic layer. In some embodiments, the second sub-dataset, after it is generated by the system, is routed and stored in the standard layer 230 or semantic layer 350. For example, after the data user requests a housing mortgage data for a specific zip code area for housing owners under 40, the dataset may be routed to the financial institution central server and stored in a standard layer storage.

In step 640, the method may include accessing the second sub-dataset by the financial institution user. In some embodiments, the system may output the second sub-dataset to the data user requesting the data after the second sub-dataset is stored in the standard layer.

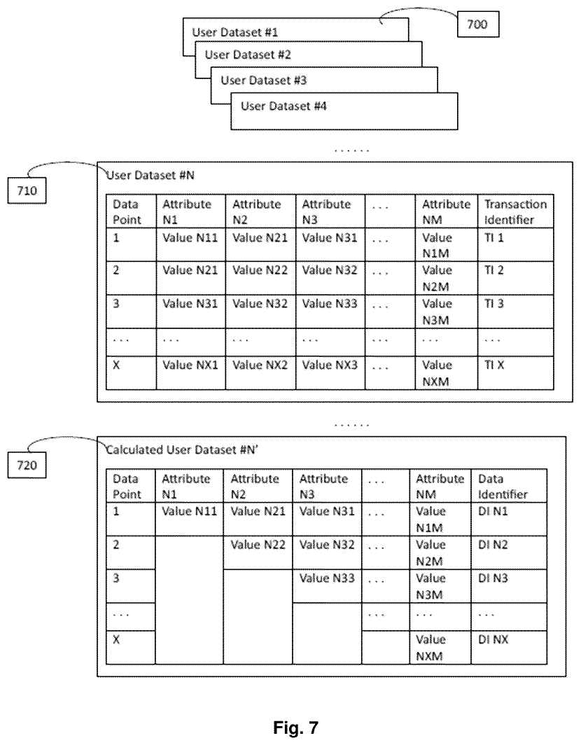

FIG. 7 is an exemplary diagram of user datasets. The dataset 700 may be an example of raw data in the stage layer 210 or ingestion layer 330. In some embodiments, a user dataset 710 is presented to a data user. The exemplary user dataset 710 is represented as the number N among all the existing datasets stored in a transactional database. The user dataset 710 may have X rows and M columns. Each data cell of the user dataset 710 may be granted a value NXM, in which N is the identifier of the dataset, X is the identifier of the row, and M is the identifier of the column. Each row of the transactional dataset 710 may include a transaction identifier TI X, in which X may correspond to the identifier of the row. In some embodiments, a calculated dataset 720 is presented to a data user. The calculated dataset 720 may also include a data identifier DI NX, which may correspond to TI X in the transactional dataset 710. The calculated dataset 720 is a calculated dataset, with the data structure refined relative to the data of transactional dataset 710. Refining data may refer to associating one or more attributes with one or more data elements based on a user request. Additionally and/or alternatively, refining may refer to differences between data presentation methods, such that a refined dataset may group data associated with a given attribute, which may facilitate presentation and/or review of data. For example, when data user requests housing prices within a certain state, attribute N1 of the calculated dataset 720 may be state information because this feature may be the same for all data cells in this dataset. In this example, the data may be grouped by state, so that users desiring to review state-specific or state-based information can review information associated with that state. The data may be refined by grouping the data by state before presenting only data associated with a single state to the user in response to a query. In a further example, attribute N2 of calculated dataset 720 can be two city names within a state, attribute N3 can be the educational level categorized into three categories, etc. Calculated datasets such as calculated dataset 720 may be smaller in size and easier for querying than user dataset 710. The transaction identifiers TI X and data identifiers DI NX enable the specific data cell to be traced back to the original data cell that contains the most comprehensive information. In some embodiments, the calculated dataset 720 includes more than three identifiers for locating each data cell. In some embodiments, the dataset includes user names, account numbers, address, salary, credit card transactions, wire transfer transactions, social security numbers, and other relevant demographic and financial transaction information.

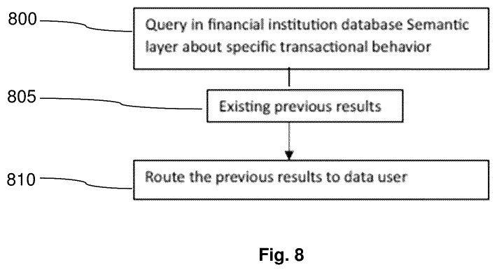

FIG. 8 is a flowchart of an exemplary method for data processing and feature recognition, according to some embodiments. The method may be performed by at least one processing device of a computing device, such as a processor in user devices 400, as described above. The method may be used to implement step 350 in the method discussed in connection to FIG. 3 above.

In step 800, the method may include querying financial institution database storage layers including standard layer 230 or semantic layer 350 about specific standardized transactional behavior. The computing device may generate the query based on the type of data feature requested. If there are existing previous results 805 stored in the standard layer 230 or the semantic layer 350, step 810 is triggered, and the previous result is routed to the data user requesting such data. For example, if the data user is querying about anti-money laundering information in general, the system will respond by querying the standard layer 230 or the semantic layer 350 first. If there are previous user requests for anti-money laundering related information or features highly related to anti-money laundering, the system may be configured to route such dataset to the current data user requesting the information.

In some embodiments, upon multiple requests of the same or similar features, for example anti-money laundering, from different data users, the system calculates and generates a third sub-dataset including data features that are frequently requested. In some embodiments, multiple requests are submitted to the system at about the same time and all of those requests would be deemed to create their respective first sub-dataset. The second sub-dataset may be normalized so that the data elements and feature attributions will be organized, making information easier to find, group, and analyze.

For example, in a financial survey determining a bank's mortgage rate, a first employee may request feature attributes including: name, account number, Social Security Number, date of birth, zip code, total credit line, and prior mortgage rate. A second employee may request name, account number, date of birth, zip code, total credit line, prior mortgage rate, and highest degree received. And a third employee may request name, account number, date of birth, zip code, total credit line, prior mortgage rate, and annual household income. The three employees may have generated their first sub-datasets in day one, and the system may provide them with a normalized second sub-dataset in day two, including name, account number, Social Security Number, date of birth, zip code, total credit line, prior mortgage rate, annual household income, and current housing value. The system may have added the customer's current housing value to the feature attributes because it is frequently requested by prior users in similar searches.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Words providing exemplary disclosures, such as “including” are intended to be inclusive, not exclusive. Thus, “including” means “including, but not limited to.” Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as examples only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as IOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file system, networking, I/O services, and provide a user interface functionality, such as a graphical user interface (“GUI”), among other things.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

Moreover, while illustrative embodiments have been described herein, the scope includes any and all embodiments having equivalent elements, modifications, omissions, combinations (e.g., aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

It is intended, therefore, that the specification and examples be considered as example only, with a true scope and spirit being indicated by the following claims and their full scope of equivalents.

What is claimed is:

1. A method for processing user transaction data associated with user transactional behaviors in a multi-layered data storage system, the method comprising:
providing a user transactional behavior dataset by a processor, the user transactional behavior dataset including:
a plurality of user transactional behavior data elements collected by a system, each of the plurality of user transactional behavior data elements including one or more feature attributes;
generating, using the processor, a first sub-dataset in a first data storage layer of the multi-layered data storage system, the first sub-dataset narrowed to user transactional behavior data elements including one or more user-requested feature attributes requested by a first user;
calculating, using the processor, approximate feature attributes of the first sub-dataset, based on one or more adjusted feature attributes;
generating, using the processor, a second sub-dataset, wherein the second sub-dataset is formed from the approximate feature attributes of the first sub-dataset attaching a data identifier feature value to each data element of the first sub-dataset, so that a data element of the second sub-dataset can be traced back to a corresponding data element in the first sub-dataset;
outputting the second sub-dataset; and
storing the second sub-dataset in a second data storage layer.

2. The method of claim 1, wherein the adjusted feature attributes are generated based on database normalization of the first sub-dataset.

3. The method of claim 1, wherein the first data storage layer is an ingestion layer.

4. The method of claim 1, wherein the second data storage layer is an integration layer.

5. The method of claim 1, wherein the second sub-dataset is a normalized dataset.

6. The method of claim 5, further comprising: outputting the normalized dataset to a graphical user interface to display on a first user device associated with the first user in a third data storage layer.

7. The method of claim 5, wherein the third data storage layer is a semantic layer.

8. The method of claim 1, wherein the adjusted feature attributes are provided by user device associated with the first user.

9. The method of claim 7, further comprising:
granting access to the second sub-dataset to a second user device; and
receiving, from the second user device, a second data request including at least one approximate feature attribute requested by the first user.

10. The method of claim 9, further comprising: generating, upon multiple requests of a same approximate features attribute by different users, a third sub-dataset including one or more data features common to the multiple requests.

11. A system for processing user transaction data associated with user transactional behaviors in a multi-layered data storage system, the system comprising:
a first memory storing instructions;
a processor configured to execute the instructions to:
collect at least one user transactional behavior dataset, the user transactional behavior data including a plurality of user transactional behavior data elements, each user transactional behavior data element in the plurality of user transactional behavior data elements including one or more feature attributes;
generate a first sub-dataset in a first data storage layer of the multi-layered data storage system, the first sub-dataset including one or more feature attributes requested by a first user;
calculate one or more approximate feature attributes of the first sub-dataset, based on one or more adjusted feature attributes;
generate a second sub-dataset, wherein a data identifier feature value is attached to each data element of the second sub-dataset, so that each data element of the second sub-dataset can be traced back to a corresponding data element in the first sub-dataset; and
provide the second sub-dataset to a second user device associated with a second user in response to a request from the second user device, the request including the one or more approximate feature attributes;
a second memory, configured to host the first data storage layer, storing the first sub-dataset; and
a third memory, configured to host a second data storage layer, storing the second sub-dataset.

12. The system of claim 11, further comprising: a fourth memory, configured to host a third data storage layer, storing a third sub-dataset, the third sub-dataset including data features that have been previously requested by multiple users.

13. The system of claim 11, wherein the adjusted feature attributes are generated based on database normalization of the first sub-dataset.

14. The system of claim 11, wherein the first data storage layer is an ingestion layer.

15. The system of claim 11, wherein the second data storage layer is an integration layer.

16. The system of claim 11, wherein the second sub-dataset is a normalized dataset.

17. The system of claim 11, wherein the second sub-dataset is a calculated dataset.

18. The system of claim 16, further comprising: instructions to output the normalized dataset to a graphical user interface to display on a first user device associated with the first user in a third data storage layer.

19. The system of claim 12, wherein the third data storage layer is a semantic layer.

20. The system of claim 11, wherein the adjusted feature attributes are provided by user device associated with the first user.
